(19) United States
(12) Patent Application Publication
(10) Pub. No.: US 2010/0083134 A1
(43) Pub. Date: Apr. 1, 2010

(54) DELEGATION OF CALENDAR FUNCTIONS

(75) Inventors: Thomas Gnech, Ammerbuch (DE); Steffen Koenig, Heidelberg (DE); Oliver Petrik, Stuttgart (DE); Holger S. Scheller, Meckesheim (DE)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/239,938

(22) Filed: Sep. 29, 2008

(51) Int. Cl. G06F 3/048

(52) U.S. Cl. 715/753

(57) ABSTRACT

A method for an electronic calendar and scheduling application to form a joined calendar during delegation of scheduling assignments includes: delegating calendar access from a first user to a second user in response to a command from the first user; wherein the first and second user maintain separate personal calendars with calendar entries with corresponding calendar entry identification (CID); generating a joined calendar view with the calendar entries from the second user's separate personal calendar; comparing each of the calendar entries with the first user's calendar entries; wherein in the event an entry from the calendar entries belonging to the first user is not duplicated during the comparing: merging the entry into the joined calendar; wherein in the event an entry from the first user's calendar entries is duplicated during the comparing: notating the duplication in the joined calendar; and displaying the joined calendar to the second user.

### BACKGROUND

This invention relates generally to electronic scheduling software, and more particularly to providing a method and system for an electronic calendar and scheduling application with a joined calendar that provides a single display view, for a plurality personal schedules, during a delegation of scheduling assignments.

Electronic calendar and scheduling programs have become a central feature of modern life and have become quite prevalent in and out of the work environment. For example, during the course of one day of travel, a user may utilize an electronic calendar and scheduling application at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day. The widespread use of electronic calendar and scheduling applications has increased the demands for improved features, ease of use, and enhanced productivity solutions.

### SUMMARY

Embodiments of the present invention include a method, article, and system for an electronic calendar and scheduling application to form a joined calendar during delegation of scheduling assignments, the method includes: delegating calendar access from a first user to a second user in response to a command from the first user; wherein the first user and second user maintain separate personal calendars with one or more calendar entries with corresponding calendar entry identification (CID); generating a joined calendar view with the one or more calendar entries and their corresponding CID from the separate personal calendar belonging to the second user; comparing each of the one or more calendar entries and their corresponding CID with the one or more calendar entries and their corresponding CID from the separate personal calendar belonging to the first user; wherein in the event an entry from the one or more calendar entries belonging to the first user is not duplicated during the comparing: merging the entry into the joined calendar; wherein in the event an entry from the one or more calendar entries belonging to the first user is duplicated during the comparing: notating the duplication in the joined calendar; and displaying the joined calendar to the second user.

An article comprising one or more computer-readable storage media containing instructions that when executed by a computer enables a method for alerting teleconference participants, the method includes: delegating calendar access from a first user to a second user in response to a command from the first user; wherein the first user and second user maintain separate personal calendars with one or more calendar entries with corresponding calendar entry identification (CID); generating a joined calendar view with the one or more calendar entries and their corresponding CID from the separate personal calendar belonging to the second user; comparing each of the one or more calendar entries and their corresponding CID with the one or more calendar entries and their corresponding CID from the separate personal calendar belonging to the first user; wherein in the event an entry from the one or more calendar entries belonging to the first user is not duplicated during the comparing: merging the entry into the joined calendar; wherein in the event an entry from the one or more calendar entries belonging to the first user is duplicated during the comparing: notating the duplication in the joined calendar; and displaying the joined calendar to the second user.

A system for an electronic calendar and scheduling application, the system includes: one or more computing and communication devices in communication through a network; wherein the one or more computing and communication devices are configured to do the following: delegate calendar access from a first user to a second user in response to a command from the first user; wherein the first user and second user maintain separate personal calendars with one or more calendar entries with corresponding calendar entry identification (CID); generate a joined calendar view with the one or more calendar entries and their corresponding CID from the separate personal calendar belonging to the second user; compare each of the one or more calendar entries and their corresponding CID with the one or more calendar entries and their corresponding CID from the separate personal calendar belonging to the first user; wherein in the event an entry from the one or more calendar entries belonging to the first user is not duplicated during the comparing: merge the entry into the joined calendar; wherein in the event an entry from the one or more calendar entries belonging to the first user is duplicated during the comparing: notate the duplication in the joined calendar; and display the joined calendar to the second user.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates separate calendar views available during delegation of calendar assignments in existing calendar and scheduling applications.

FIG. 2 illustrates a functional diagram with a joined calendar view of the individual schedules of FIG. 1 according to embodiments of the invention.

FIG. 3 is a flow chart for performing a function for adding a calendar entry for a person in a joined calendar according to embodiments of the invention.

FIG. 4 is a flow chart for performing a function for deleting a calendar entry for a person in a joined calendar according to embodiments of the invention.

FIG. 5 illustrates a flow chart for a method for an electronic calendar and scheduling application to form a joined calendar during a delegation of scheduling assignments according to embodiments of the invention.

FIG. 6 illustrates a system for implementing embodiments of the invention.

The detailed description explains the preferred embodiments of the invention, together with advantages and features, by way of example with reference to the drawings.

### DETAILED DESCRIPTION

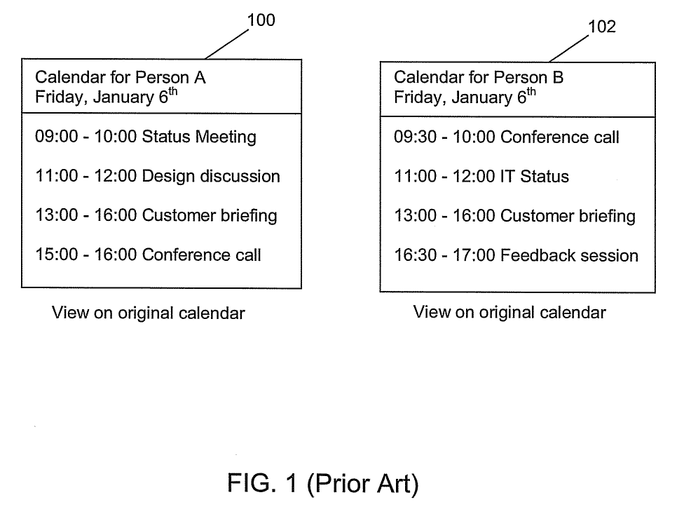

Electronic calendar and scheduling programs and software products are configured for the effective time management of users. In a typical office communication system, calendar functions are provided to different persons within an organization, while supporting delegation of functionality between the different people. Delegation of functionality is a feature that allows one person to make entries and adjustments on another person's calendar. For example, if person “B” delegates the usage of calendar functions to person “A”, then person “A” has to handle two calendars at a time, both their own and the calendar of person “B.” FIG. 1 illustrates separate calendar views available during delegation of calendar assignments in existing calendar and scheduling applications.

In FIG. 1 separate calendar views are maintained for each individual user. Person “A” has their schedule on a calendar view 100, while person “B” has their schedule on a calendar view 102. The separate views allow operations only in one view at a time, with either read-only rights or delegation rights. With read only rights a user is allowed to look at another person's calendar entries, or to perform a free-time check while preparing a meeting invitation, but no modification to calendar entries may be made. With delegation rights a transferring of action/access rights for a personal calendar to another person takes place, while keeping separate views on the personal calendars, no joining modifications are possible. With existing calendar and scheduling applications, the separate calendar views, require a user who has been delegated responsibility for making calendar entries for others, to view separate calendars for each individual that has been delegated to them. Working on separate calendars is ineffective and error prone, especially as the level of complexity increases with the number of additional delegations.

Embodiments of the invention provide a method and system for an electronic calendar and scheduling application with a joined calendar that provides a single display view, for a plurality of personal schedules, during a delegation of scheduling assignments. The joined calendar, of embodiments of the invention, displays calendar entries for a plurality of people in a single view, while maintaining the entries in a distinguishable manner, such as by using color-coding or different fonts for the different people related entries. In order to avoid duplicate entries from the different individual calendars or schedules, embodiments of the invention assign a “Calendar Entry Identification” (CID) to uniquely identify a specific calendar entry globally across individual calendars, where the individual calendars may even reside in different calendar systems, and within the joined calendar. The different calendar systems may be implemented on servers from the same or different manufacturers (e.g., two or more Lotus Domino servers, or a Lotus Domino server and a Microsoft Outlook server). In embodiments of the invention, appending a random number to an email address of the person who creates the calendar entry may generate a CID. In additional embodiments, appending a number, which is unique within the originating (personal or joined) calendar to the unique name or ID of the originating (personal or joined) calendar.

The joined calendar view, of embodiments of the invention, is configured for making updates to existing entries, and additional new entries to the joined calendar view that are also reflected in the individual personal calendars, while keeping the individual personal calendar's information separate.

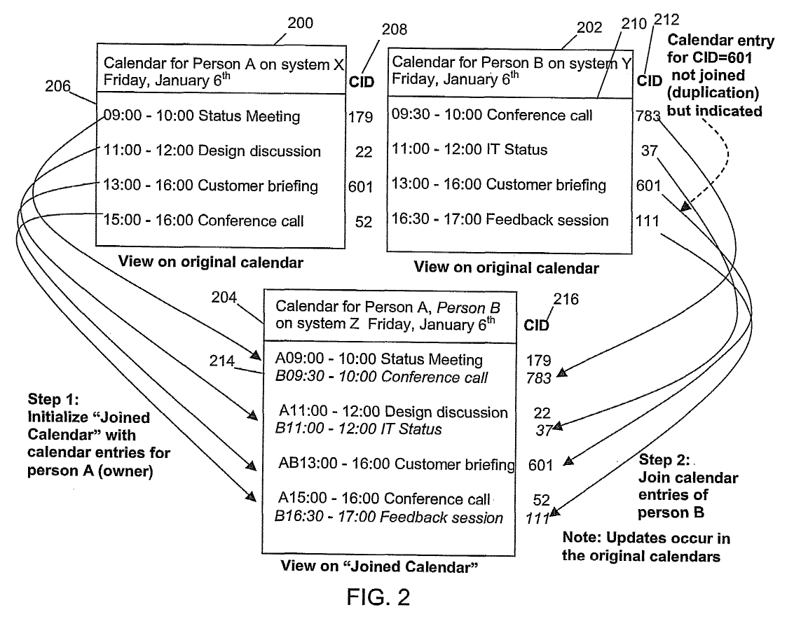

FIG. 2 illustrates a functional diagram with a joined calendar view of the individual schedules of FIG. 1 according to embodiments of the invention. In the embodiment of the invention of FIG. 2, the separate calendar views of FIG. 1 are maintained for each individual user with Person “A” having their schedule 206 on a calendar view 200 on calendar system X, while person “B” has their schedule 210 on a calendar view 202 on calendar system Y. The individual schedule entries 206 and 210 are individually assigned a CID under column 208 and 212, respectively. In the scenario depicted in FIG. 2, person “B” delegates calendar access to person “A”. In response to the delegation by person “B” to person “A”, a joined calendar 204 is formed for person “A”, by initializing the joined calendar 204 with entries for person “A” from their original individual schedule entries 206, and their corresponding CID column 208. Subsequently, the schedule entries 210 and their corresponding CID column 212 for person “B” are joined with person “A” entries to form the joined calendar 204 on calendar system Z. It is noted that entries from separate calendars with identical CID are not joined, but indicated in the joined calendar entries 214. In the example of FIG. 2, the entry with CID 601 (13:00-16:00 Customer briefing) appears in both person “A” calendar view 200 and person “B” calendar view 202, and is therefore not joined in the joined calendar 204, but indicated in the joined calendar entries 214 with the designation “AB” for both person “A” and person “B”. It is noted that calendar systems X, Y, and Z may represent the same system, separate installations, or different calendar products. The calendars, both personal and joined, may reside in the same calendar system.

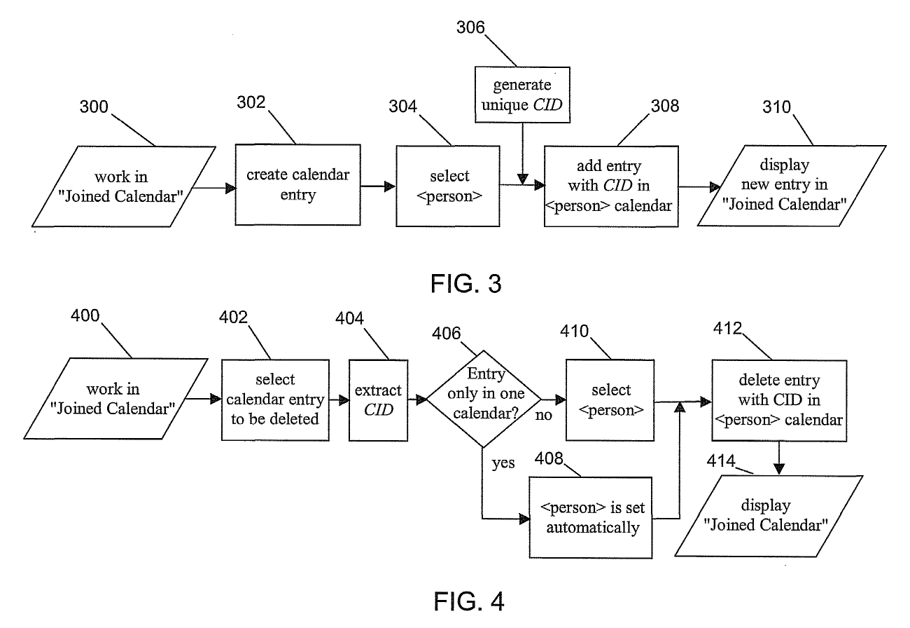

FIG. 3 is a flow chart for performing a function for adding a calendar entry for a person in a joined calendar according to embodiments of the invention. The function begins while working in a joined calendar (block 300) with the creation of a calendar entry (block 302) and the selection of a person to attribute to the calendar entry (block 304). Subsequently, a unique CID is generated (block 306) and assigned to the calendar entry in the individual person calendar (block 308), and also displayed as an entry in the joined calendar (block 310).

FIG. 4 is a flow chart for performing a function for deleting a calendar entry for a person in a joined calendar according to embodiments of the invention. The function begins while working in a joined calendar (block 400) with the selection of a calendar entry to be deleted (block 402). Subsequently, the CID associated with the calendar entry selected for deletion is extracted (block 404), and in the event the selected entry appears in only one calendar (decision block 406 is yes) the corresponding person's calendar is set automatically (block 408), and the entry with the CID is deleted in the corresponding person's calendar (block 412), and the deletion is reflected in the joined calendar (block 414). In the event the selected entry appears in more then one calendar (decision block 406 is No), the person for whom the entry is to be deleted is selected (block 410), and the entry with the CID is deleted in the corresponding person's calendar (block 412) and the deletion is reflected in the joined calendar (block 414).

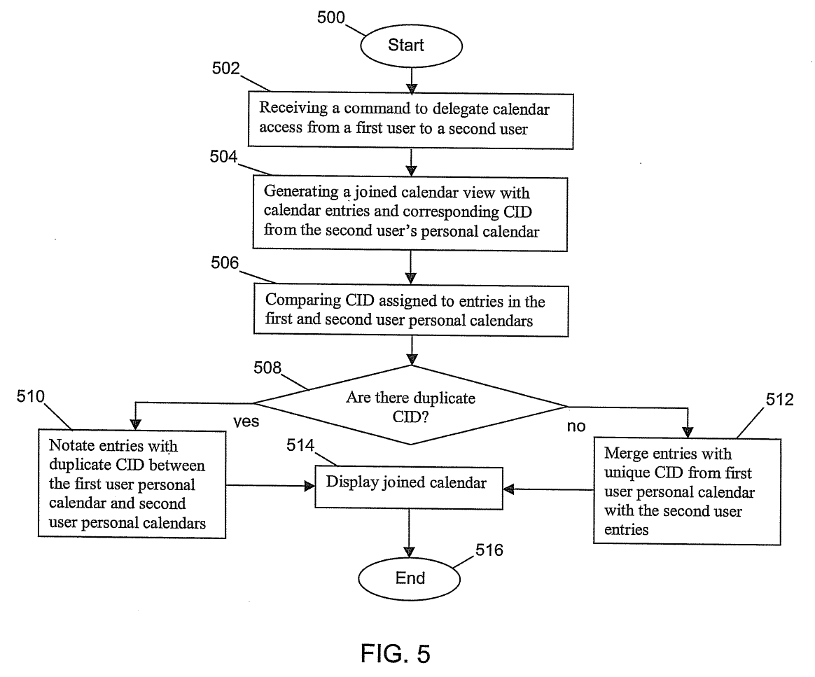

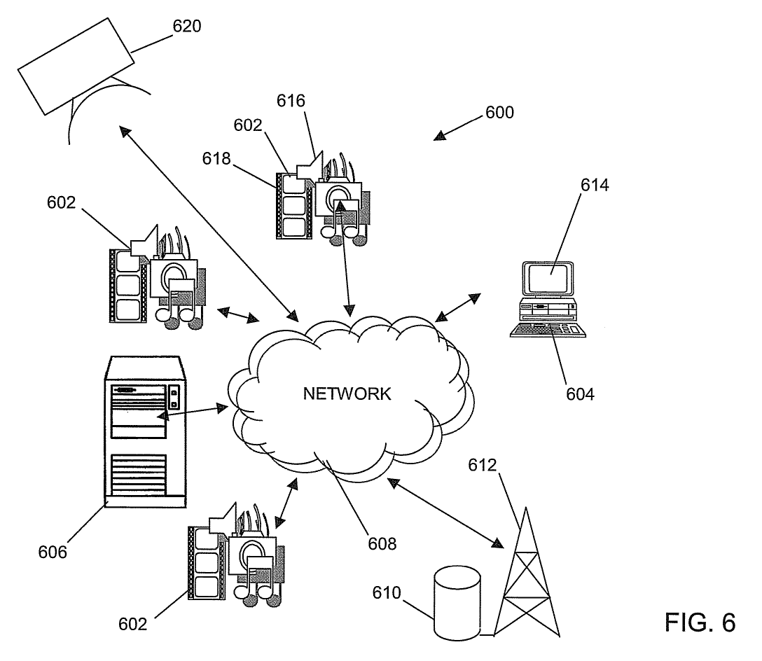

FIG. 5 illustrates a flow chart for a method for an electronic calendar and scheduling application to form a joined calendar during a delegation of scheduling assignments according to embodiments of the invention. The process starts (block 500) with the receiving of a command to delegate calendar access from a first user to a second user (block 502). Subsequently, a joined calendar view is generated with calendar entries and corresponding CID from the second user's personal calendar (block 504), and the CID assigned to entries in the first and second user personal calendars are compared (block 506). In the event there are duplicate CID between the first and second user personal calendar entries (decision block 508 is Yes), entries with duplicate CID between the first user personal calendar and second user personal calendar are notated (block 510). In the event an entry in the first user calendar does not have a duplicate CID with the second user personal calendar entries (decision block 508 is no), the entries with unique CID from the first user personal calendar are merged with the second user entries (block 512). Finally, a joined calendar is displayed (block 514) with the merged and notated calendar entries, and the process concludes (block 516).

FIG. 6 illustrates an exemplary system 600 for an electronic calendar and scheduling application with a joined calendar that provides a single display view, for a plurality of personal schedules, during a delegation of scheduling assignments. The system 600 includes multimedia devices 602, and desktop computer devices 604 configured with display capabilities 614. The multimedia devices 602 may be mobile communication and entertainment devices, such as cellular phones and mobile computing devices that are wirelessly connected to a network 608. The multimedia devices 602 have video displays 618 and audio outputs 616. The multimedia devices 602 and desktop computer devices 604 may be configured with calendar and scheduling software with a graphical user interface (GUI) for implementing embodiments of the invention. The network 608 may be any type of known network including a fixed wire line network, cable and fiber optics, over the air broadcasts, satellite 620, local area network (LAN), wide area network (WAN), global network (e.g., Internet), intranet, etc. with data/Internet capabilities as represented by server 606. Communication aspects of the network are represented by cellular base station 610 and antenna 612.

The calendar and scheduling software of embodiments of the invention may be resident on the individual multimedia devices 602 and desktop computers 604, or stored within the server 606 or cellular base station 610.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

1. A method for implementing an electronic calendar and scheduling application to form a joined calendar during delegation of scheduling assignments, wherein the method comprises:
delegating calendar access from a first user to a second user in response to a command from the first user;
wherein the first user and second user maintain separate personal calendars with one or more calendar entries with corresponding calendar entry identification (CID);
generating a joined calendar view with the one or more calendar entries and their corresponding CID from the separate personal calendar belonging to the second user;
comparing each of the one or more calendar entries and their corresponding CID with the one or more calendar entries and their corresponding CID from the separate personal calendar belonging to the first user;
wherein in the event an entry from the one or more calendar entries belonging to the first user is not duplicated during the comparing:
merging the entry into the joined calendar;
wherein in the event an entry from the one or more calendar entries belonging to the first user is duplicated during the comparing:
notating the duplication in the joined calendar; and
displaying the joined calendar to the second user.

2. The method of claim 1, wherein the entries within the joined calendar are maintained in a distinguishable manner including color-coding and different fonts.

3. The method of claim 1, wherein the CID uniquely identifies a specific calendar entry globally across separate personal calendars;
wherein the separate personal calendars reside in at least one of: different calendar systems, and within the joined calendar; and
wherein the different calendar systems are implemented on servers from the same or different manufacturers.

4. The method of claim 1, wherein the CID is formed by at least one of:
appending a random number to an email address of a user who creates the calendar entry; and
appending a number, which is unique within an originating calendar to a unique name or identification (ID) of the originating calendar; and
wherein the originating calendar is a personal or joined calendar.

5. The method of claim 1, wherein updates to existing entries, and additional new entries in the joined calendar are also reflected in one or more separate personal calendars; and
wherein the information in the one or more personal calendars remains separate.

6. The method of claim 5, wherein the updates include addition and deletion of entries in the joined calendar.

7. An article comprising one or more computer-readable storage media containing computer readable instructions that, when executed by a computer, performs a method for implementing an electronic calendar and scheduling application to form a joined calendar during delegation of scheduling assignments, wherein the method comprises:
delegating calendar access from a first user to a second user in response to a command from the first user;
wherein the first user and second user maintain separate personal calendars with one or more calendar entries with corresponding calendar entry identification (CID);
generating a joined calendar view with the one or more calendar entries and their corresponding CID from the separate personal calendar belonging to the second user;
comparing each of the one or more calendar entries and their corresponding CID with the one or more calendar entries and their corresponding CID from the separate personal calendar belonging to the first user;
wherein in the event an entry from the one or more calendar entries belonging to the first user is not duplicated during the comparing:
merging the entry into the joined calendar;
wherein in the event an entry from the one or more calendar entries belonging to the first user is duplicated during the comparing:
notating the duplication in the joined calendar; and
displaying the joined calendar to the second user.

8. The article of claim 7, wherein the entries within the joined calendar are maintained in a distinguishable manner including color-coding and different fonts.

9. The article of claim 7, wherein the CID uniquely identifies a specific calendar entry globally across separate personal calendars;
wherein the separate personal calendars reside in at least one of: different calendar systems, and within the joined calendar; and
wherein the different calendar systems are implemented on servers from the same or different manufacturers.

10. The article of claim 7, wherein the CID is formed by at least one of:
appending a random number to an email address of a user who creates the calendar entry; and
appending a number, which is unique within an originating calendar to a unique name or identification (ID) of the originating calendar; and
wherein the originating calendar is a personal or joined calendar.

11. The article of claim 7, wherein updates to existing entries, and additional new entries in the joined calendar are also reflected in one or more separate personal calendars; and
wherein the information in the one or more personal calendars remains separate.

12. The article of claim 11, wherein the updates include addition and deletion of entries in the joined calendar.

13. A system for an electronic calendar and scheduling application, the system comprising:
one or more computing and communication devices in communication through a network;
wherein the one or more computing and communication devices are configured to do the following:
delegate calendar access from a first user to a second user in response to a command from the first user;
wherein the first user and second user maintain separate personal calendars with one or more calendar entries with corresponding calendar entry identification (CID);
generate a joined calendar view with the one or more calendar entries and their corresponding CID from the separate personal calendar belonging to the second user;
compare each of the one or more calendar entries and their corresponding CID with the one or more calendar entries and their corresponding CID from the separate personal calendar belonging to the first user;
wherein in the event an entry from the one or more calendar entries belonging to the first user is not duplicated during the comparing:
merge the entry into the joined calendar;
wherein in the event an entry from the one or more calendar entries belonging to the first user is duplicated during the comparing:
notate the duplication in the joined calendar; and
display the joined calendar to the second user.

14. The system of claim 13, wherein the entries within the joined calendar are maintained in a distinguishable manner including color-coding and different fonts.

15. The system of claim 13, wherein the CID uniquely identifies a specific calendar entry globally across separate personal calendars;
wherein the separate personal calendars reside in at least one of: different calendar systems, and within the joined calendar; and
wherein the different calendar systems are implemented on servers from the same or different manufacturers.

16. The system of claim 13, wherein the CID is formed by at least one of:
appending a random number to an email address of a user who creates the calendar entry; and
appending a number, which is unique within an originating calendar to a unique name or identification (ID) of the originating calendar; and
wherein the originating calendar is a personal or joined calendar.

17. The system of claim 13, wherein updates to existing entries, and additional new entries in the joined calendar are also reflected in one or more separate personal calendars; and
wherein the information in the one or more personal calendars remains separate.

18. The system of claim 17, wherein the updates include addition and deletion of entries in the joined calendar.

19. The system of claim 13, wherein a graphical user interface is configured to provide the joined calendar.
